(19) United States
(12) Patent Application Publication
(10) Pub. No.: US 2025/0310090 A1
(43) Pub. Date: Oct. 2, 2025

(54) DETERMINING BIAS POINTS FOR MOS DEVICE FOR QUANTUM SIGNAL GENERATION

(71) Applicant: Quintessence Labs Pty Ltd., Canberra Airport (AU)

(72) Inventors: Alvin Labios, Canberra (AU); Torsten Lehman, Sydney (AU); Julian Keledjian, Sydney (AU)

(73) Assignee: Quintessence Labs Pty Ltd., Canberra Airport (AU)

(21) Appl. No.: 19/233,082

(22) Filed: Jun. 10, 2025

Related U.S. Application Data
(63) Continuation of application No. PCT/AU2023/051334, filed on Dec. 20, 2023.
(60) Provisional application No. 63/434,046, filed on Dec. 20, 2022.

(51) Int. Cl. H04L 9/08

(52) U.S. Cl. CPC H04L 9/0852; H04L 9/0869

(57) ABSTRACT

Some embodiments present methods and systems for generating high-entropy random numbers that can be used for cryptography, utilizing an optimally biased Metal-Oxide-Semiconductor (MOS) device to produce a quantum signal. Adjustment to bias may be made based on a measure of a normalized power spectrum distribution (NPSD). NPSD may also confirm quantum tunneling effects. Bias current or voltage may be adjusted to maintaining signal entropy and ensure a quantum source for random number generation.

### CROSS-REFERENCES TO RELATED APPLICATIONS

This application is a continuation of International Application No. PCT/AU2023/051334, filed Dec. 30, 2023, which claims priority to U.S. Provisional Patent Application No. 63/434,046 filed Dec. 20, 2022, which is commonly owned and incorporated in its entirety herein by reference.

### BACKGROUND

Random number generation is a cornerstone of modern encryption and cryptographic systems. The quality of random numbers is determined by the entropy of the source, commonly measured by statistical methods. In cryptosystems and other cryptography applications, the strength of security is related to the quality of the cryptographic keys. Random bit generators can generate streams of random bits, which can be used for cryptographic keys. The best cryptographic keys are a sequence of completely random bits, which are independent and identically distributed (IID), meaning that each bit value has an equal probability of occurring and all values are mutually independent. Current entropy sources in random number generation largely rely on pseudo-random number generators, which are deterministic and may lead to vulnerabilities in encryption systems.

Quantum sources of signals may provide entropy sources which are truly random. Quantum signal generation for random number creation has relied on specialized components. One example of such a device is a “Tunnel Diode”, known for its ability to exploit quantum mechanical effects. However, these components are not only rare and difficult to source but also expensive, limiting their practicality for widespread application.

In contrast, metal-oxide semiconductor (MOS) or complementary metal-oxide semiconductor (CMOS) devices are ubiquitous and economical, offering a potential alternative for generating quantum signals. However, MOS or CMOS devices present a unique challenge: the quantum signal they produce is inherently weak compared to the main bias current, or other noise in the system (e.g., “floor noise”), making it difficult to harness for reliable quantum signal generation. Isolation of the quantum signal being generated and verification that such a signal is generated from quantum effects is thus a limiting factor to the use of MOS or CMOS devices.

Further, the weakness of the quantum signal in MOS devices can be exacerbated by environmental factors such as temperature fluctuations and electromagnetic interference (EMI), which can further diminish or distort the quantum signal. Additionally, the operation of MOS devices in a quantum signal generation mode is challenging due to the narrow and specific operating points (such as for current, voltage, power, or frequency) required for optimal quantum signal generation. These operating points are not only difficult to determine theoretically but also vary significantly across individual devices due to manufacturing tolerances. Over time, the characteristics of the MOS material may also degrade or change, further complicating consistent operation.

Currently, there are no methods capable of dynamically and accurately adjusting the bias of MOS devices to maintain optimal quantum signal generation over time and under varying environmental conditions. Therefore, there exists a need for improved methods and systems that addresses these challenges and enable the practical application of MOS devices in quantum signal generation, which may be used in cryptographical applications, such as but not limited to random number generation.

### TERMS

The terms provided herein are intended solely to aid in the comprehension of some embodiments described in this document. They are not to be considered exhaustive or universally applicable to all embodiments. These definitions are meant for illustrative purposes only and should not be construed as limiting the scope of the embodiments.

Bias can refer to a current, voltage, frequency, or other electrical state, which may be use adjusted to change the behavioral state of a CMOS or MOS device.

A Cryptosystem can include a cryptography module that uses one or more cryptographic algorithms to implement a security service.

A Cryptographic key can be a sequence of bits used by a cryptographic algorithm.

An Independent and identically distributed (IID) sequence of bits can be a sequence of bits where each element of the sequence has an equal probability of occurring and all values are mutually independent.

Entropy can be a measure of uncertainty, unpredictability or randomness of a system.

A Full-entropy sequence of bits can be a sequence of bits that is effectively indistinguishable from independent and identically distributed bits.

A Random bit generator can be a device or algorithm that outputs a random sequence of full-entropy bits.

A Non-deterministic random bit generator can be a random bit generator that has access to a properly functioning entropy source and produces full-entropy bit sequence.

An Entropy Source can be a device that that has access to a noise source and outputs a random sequence of full-entropy bits.

A Noise Source can be a component of an entropy source that contains non-deterministic entropy-producing activity.

A Digitization component can be a component of an entropy source that converts the output of a noise source to a sequence of bits.

A Conditioning component can be an (optional) component of an entropy source and an implementation of an algorithm that increases the entropy density of the output bits.

A Diode can be a two-terminal electronic component that allows current flow primarily in one direction.

A Poisson distribution can be a discrete probability distribution that describes a number of independent discrete events occurring in a fixed time-interval.

Shot noise (or Poisson noise) can describe the variability in the number of events occurring per time-interval.

Quantum Signal (or QS) can describe a signal, which can be analog, which is generated from quantum mechanical effects. In some embodiments, the generation can occur when a portion of current “tunnels” through a junction and a portion of the current corresponding to the “tunneling” may be filtered and extracted as a quantum signal.

Power Spectral Density (PSD) can provide a detailed view of how the power of a signal is distributed across different frequencies. Essentially, it can break down the signal into its constituent frequencies and show the power present at each frequency component. PSD can be useful in identifying the dominant frequencies within a signal and understanding its overall behavior in the frequency domain. In the context of random number generation, especially in cryptographic applications, PSD can be a tool for ensuring that the signal's power is evenly distributed across the relevant frequency band, a characteristic of high-quality, high-entropy signals.

### SUMMARY

Some embodiments described herein seek to address the limitations of deterministic systems by providing a true random number generator (TRNG) that exploits the quantum mechanical phenomenon of tunneling within standard MOS or CMOS structures to generate high-entropy random numbers.

The invention discloses an on-chip quantum noise source that leverages the quantum tunnelling effect in MOS structures to generate gate-referred shot noise, which serves as an entropy source in TRNGs. The described noise source is capable of generating random numbers with high entropy and consistent performance. In some embodiments, the MOS structure may achieve performance consistent with test compliances.

Some embodiments described herein provide methods and systems for optimizing the biasing of MOS devices to enhance quantum signal generation for the purpose of high-entropy random number generation, particularly useful in cryptographic applications. This invention addresses the need for a dynamic and accurate adjustment of the bias in MOS devices to maintain optimal quantum signal generation under varying conditions and over time.

Some embodiments described herein include a method for dynamically adjusting and optimizing the biasing of a MOS device to enhance the output of quantum signals. Disclosed methods ensure that devices operate within a range conducive to promoting quantum tunneling effects that may be useful for high-quality random number generation. The invention may commence with the evaluation of the MOS device to ascertain its suitability for generating a quantum signal. Following this, an initial bias current may be applied to the device, including a process for iterative adjustment of this bias to reach an optimal point for quantum signal generation.

Some embodiments described herein relate to an analysis of the quantum signal output from the MOS device, focusing particularly on the power spectrum of the non-amplified or amplified quantum signal. This process includes the generation of a Power Spectrum Distribution (PSD) or Normalized Power Spectrum Distribution (NPSD) to evaluate the presence and quality of quantum tunneling effects. In some embodiments, an optimization or change algorithm may be used to modify bias settings based on the analysis. In some examples, the algorithm takes into account the device's power spectrum, environmental factors, and the desired frequency of operation. The algorithm may be used to improve the quality of the quantum signal for a particular purpose. In some examples, a bias modification algorithm (e.g., a change algorithm) may increase or enhance the quantum signal. Due to complex effects related to voltage, electrical stress, degradation, avalanche effects, forward bias behaviors, an algorithm may obtain a more optimum quantum signal.

Some aspects of the disclosed invention may provide advantages, including enhanced quantum signal generation by optimizing a bias point, reduction or mitigation of the impact of environmental factors such as temperature variations and electromagnetic interference, adaptability to variances in manufacturing of MOS devices, and extended device lifespan by avoiding sub-optimal operating points (e.g., sub-optimal bias points). Some aspects of the disclosed invention provide a novel approach to utilizing standard MOS devices for quantum signal generation, providing a practical, efficient, and cost-effective solution to the challenges previously encountered in this field. It is particularly advantageous in the field of cryptography, where it can be used to generate high-entropy random numbers for secure key generation, addressing a critical need in the industry for more reliable and cost-effective methods of producing cryptographic keys.

Some embodiments described herein enable analysis of a MOS device capable of strong biasing to facilitate quantum tunnelling and hence generate a desired shot noise. Some embodiments may be optimized for implementation in a commercial fabrication processes, balancing the need for high entropy with concerns for device longevity, cost, and fabrication practicality. As one non-limiting example, the process node of the MOS devices may be between 5 nm and 40 nm. However, any process node may be used which exhibits the quantum effects described herein.

Some embodiments described herein describe a method for optimizing a bias setting in a semiconductor device to facilitate quantum signal generation. The method may comprise any combination of determining a theoretical behavior for the semiconductor device; measuring a power spectrum associated with the quantum signal from the semiconductor device for a first bias setting; normalizing the measured power spectrum to generate a distribution indicative of quantum tunneling effects; and adjusting the first bias setting based on the normalized power spectrum to a second bias setting to improve the quantum signal for random number generation. The method may further compromise measuring an entropy content of content derived from the quantum signal. The entropy content may be indicative of a quality of randomness which may be used for cryptographic key generation. The semiconductor device may be a Metal-Oxide Semiconductor (MOS) device. The method may include determining suitability of the device for quantum signal generation. Determining suitability may include assessing whether the semiconductor device can produce a measurable quantum signal, the strength of the quantum signal relative to a floor noise source, or other comparisons of the quantum signal or quantum effect of the MOS device. The method may include analyzing a normalized power spectrum to detect the presence of quantum effects, including quantum tunneling effects. A first bias setting may be generated based on an initial noise floor power determination of the semiconductor device. Normalizing the measured power spectrum may include using a factor related to the elementary charge of an electron and the bias current. A second bias setting may be adjusted iteratively based on a continuous feedback loop involving one or more normalized power spectra. Random number generation may be used in a cryptographic process. The improved or optimized quantum signal may be stored in a memory unit prior to a process of random number generation. The semiconductor device may comprise a plurality of semiconductors or a plurality of MOS devices. A plurality of bias settings may be generated across the plurality of MOS devices to produce a composite quantum signal from each of MOS devices. The theoretical behavior for the semiconductor device may be based on Fowler-Nordheim (FN) effects. The theoretical behavior may be used to determine a zero line (e.g., a 0 dB line) against which to compare a power spectrum or normalized power spectrum for quantum effects. The zero line may be used to determine the quantum and non-quantum effects, and may be compared against to enhance the quantum signal.

Some embodiments described herein describe a method for generating random numbers. The method may comprise assessing the suitability of a MOS device for generating quantum tunnelling-based shot noise; biasing the MOS device to induce quantum tunnelling or quantum effects; measuring the generated shot noise and evaluating an entropy content of the measured noise; post-processing the measured noise to remove biases and increase entropy density; and utilizing the processed noise as a source of entropy in random number generation for cryptographic applications.

Some embodiments described herein include a system for generating random numbers. The system may be configured to perform any of the method steps herein. The system may comprise a semiconductor structure designed to exhibit quantum tunnelling effects when subjected to a suitable bias current; a biasing module configured to adjust the bias current to increase the quantum tunnelling effects within said semiconductor structure; a noise measurement module configured to capture a shot noise generated by the quantum tunnelling effect; a data processing module configured to evaluate entropy of the generated random numbers based on the captured shot noise; a conditioning module configured to apply post-processing techniques to the generated random numbers to enhance entropy density. The semiconductor device may be a MOS structure. The MOS structure may be fabricated using a commercial or standard MOS process where the feature size is no larger than 40 nm. The MOS structure may contain a triangular barrier as part of the structure. The MOS structure may be designed or be expected to produce Fowler Nordheim tunneling. In some examples, the most optimum biasing point (e.g., a frequency) may be obtained.

In some embodiments, a differential setup may be used for one or more MOS devices. Biasing may be performed independently for each of a plurality of MOS devices and to obtain a biasing point or frequency point for each device. In some non-limiting embodiments, bias may refer to a operational setting, minimum setting, voltage, current, other electrical property, or an entire response curve (e.g., an NPSD or PSD curve).

These and other embodiments along with many of its advantages and features are described in more detail in conjunction with the text below and attached figures.

### BRIEF DESCRIPTION OF THE DRAWINGS

FIG. 1 shows a functional component-level signal flow diagram of an entropy source according to some embodiments of the invention.

FIG. 2 shows an example system configured to measure and adjust bias to a metal-oxide semiconductor (MOS) device according to embodiments of the invention.

FIG. 3 is a plot illustrating various power spectrum distributions at various bias settings according to some embodiments of the invention.

FIG. 4 is a method to determine an improved bias setting for a MOS device to increase quantum tunneling effects in the MOS device according to some embodiments of the invention.

FIG. 5 is a simplified block diagram illustrating a cryptographic key management system according to some embodiments of the invention; and

FIG. 6 is a simplified block diagram illustrating an example of a computer system according to some embodiments of the invention.

### DETAILED DESCRIPTION

In some embodiments of the present invention, a MOS component is used to produce an electric current that exhibits quantum effects. The quantum signal generated from the quantum effect is a source of non-deterministic, entropy-producing activity. This electrical current is converted to a voltage and then filtered and amplified before being digitized. The entropy of the system or MOS component may be measured based on a power spectrum distribution of the device or component. The system may be used in various applications which rely on random information sources, including random number generation and cryptographic applications.

Some embodiments of the present invention may be comprised of electronic components. These components can be independent electronic components on a discrete circuit or integrated components in an integrated circuit. In the latter case, embodiments of this invention can have reduced form-factor, power, and cost compared with the former.

Some embodiments of the present invention can include a cryptosystem. In cryptography, a cryptosystem consists of cryptographic algorithms and cryptography keys that are used to protect digital information. A cryptosystem can require random bits, for example, randomly generated cryptographic keys, etc.

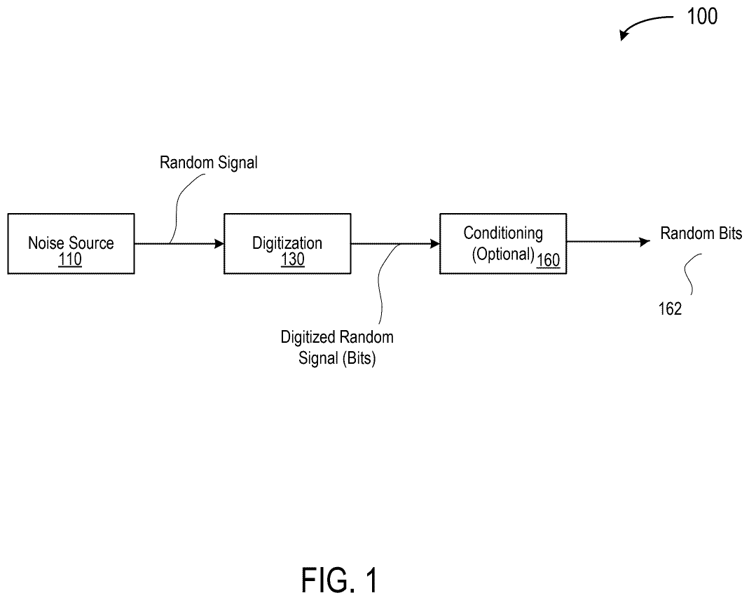

Some embodiments of the present invention can include an entropy source. A cryptographic entropy source may be a device that can produce a sequence of full-entropy, random bits. Full-entropy, random bits can be independent and identically distributed (IID) and may be indistinguishable from true-random bits. As one example, the National Institute of Standards and Technology provide recommendations for construction of an entropy source (Ref NIST SP 800 90B (2nd Draft)), which includes: a noise source, a digitizer and an (optional) conditioning component. FIG. 1 shows an example functional component-level signal flow diagram of an entropy source.

As used herein, optimization may refer to the process of improving or increasing a signal. A person of skill in the art will appreciate that optimization need not produce a global optimal but rather an improved signal, such as one with a larger quantum effect or an improved signal.

Prior to a discussion of example embodiments, an overview of tunneling and suitability of Fowler-Nordheim (FN) tunneling for quantum signal generation for MOS devices is provided.

### I. Overview of Tunneling Sources and Application to Commercial MOS Devices

FN tunneling is particularly desirable for MOS devices due to its suitability as an entropy source for random number generation. This preference stems from the unique characteristics of FN tunneling in enhancing the signal-to-noise ratio (SNR) and enabling effective entropy generation.

In semiconductor devices, Esaki or tunneling diodes can serve as entropy sources when operated at specific points on their current-voltage (I-V) curve. This operation aligns the conduction band of an N-type semiconductor with the valence band of a P-type semiconductor, maximizing tunneling and, consequently, the signal to noise ratio (SNR). Thus, commercially available tunnel diodes may be used in random number generators, strategically biased to maximize tunneling current. Yet, the requirement for degenerately doped junctions in these diodes often renders them impractical for standard MOS processes due to design rule constraints.

Other types of diodes have similar limitations for use in commercial applications. For example, Zener diodes, offering a more moderate doping level, can be reverse-biased to promote quantum tunneling, though care must be taken to avoid avalanche events that could decrease entropy.

Shot noise, arising from the discrete nature of charge movement across a discontinuous junction, is another consideration. It may manifest as spectrally white and Poisson distributed noise in the time domain, which is desirable for randomness. This type of noise correlates with the bias current, providing a measure to control entropy sources quality.

In the context of MOS devices, FN tunneling is advantageous because it allows for the formation of a thin potential barrier via an insulating oxide layer in a MOSFET structure. SNR of the entropy source is directly related to the achievable bias current, offering a way to either increase the electric field across the barrier or reduce its width, enhancing the probability of tunneling events.

However, there is a need to balance this against the risk of dielectric breakdown, which could severely limit device lifespan and effectiveness. FN tunneling is particularly prominent under conditions of high bias, where the barrier appears triangular, as opposed to direct tunneling, which occurs under low bias or thin oxide barriers.

Thus, the preference for FN tunneling in MOS devices can be attributed to its ability to operate at high bias, enhancing the power spectral density (PSD) of the process, a factor in random number generation. The control over bias voltage remains a primary method for tuning these devices, given the constraints in selecting oxide thickness in commercial manufacturing processes. This control over the tunneling mechanism makes FN tunneling a highly desired feature in MOS devices for applications requiring robust and high-entropy random number generation.

As further explained below, FN-tunneling is optimzied through some embodiments of the invention, as provided in the example systems and methods below.

### II. Example Systems and Methods

FIG. 1 shows a functional component-level signal flow diagram of a random bits generator according to some embodiments of the present invention. As shown in FIG. 1, random bits generator 100 includes a noise source 110, a digitizer 130, and an (optional) conditioning component 160.

As illustrated in FIG. 1, random bits generator 100 includes a noise source 110. Noise source 110 is configured for producing a non-deterministic, entropy-producing activity. This activity is converted into a measurable randomly-varying signal, for example an electric voltage or an electric current. The output values of the noise source, random signal, can be either discrete or continuous (digital or analog).

Random bits generator 100 includes a digitization component 130, which is used to convert the output from the noise source into digital values (bits), i.e., digitized random signal bits. An example of a digitizer includes an analog-to-digital (ADC) converter.

Random bits generator 100 can also include a conditioning component 160. In FIG. 1, conditioning component 160 is an implementation of a deterministic algorithm, which acts on the digitized signal to reduce the bias and/or increase the entropy density of the output bits. The output bits 162 from a well-constructed conditioning component are full-entropy, uniformly distributed and random.

Some embodiments of the present invention can include a random bit generator. The cryptographic entropy source may itself be a subcomponent of a random bit generator (RBG). A random bit generator can use the full-entropy random bit sequence, which is produced by its internal entropy source component, to produce cryptographic keys for cryptosystems and other cryptographic applications.

In some embodiments of the present invention, noise source 110 can include electric current and shot noise. Shot noise can be used as the entropy producing activity in a cryptographic noise source. Shot noise arises in systems described by a Poisson distribution whereby a random number of discrete events occur in a given time-interval. Shot noise (or Poisson noise) describes the fluctuations in the number of events occurring per time-interval. Shot noise is present in electronics because electrons are discrete fundamental energy packets. An electric current describes the number of electrons per second. An electric current exhibits shot noise arising from the fluctuations in the number of electrons per second. Shot noise may be dominant when the finite number of particles that carry energy (such as electrons in an electronic circuit or photons in an optical device) is sufficiently small so that uncertainties due to the Poisson distribution, which describes the occurrence of independent random events, are of significance.

Shot noise can be observed in electronic components, for example, electronic diodes or in MOS devices. A diode is a two-terminal electronic component that allows current flow primarily in one direction. A semiconductor diode consists of p-type and n-type semiconductors placed in junction with each another. A p-n diode is a type of semiconductor diode based upon the p-n junction, which is an interface between p-type and n-type semiconducting layers. N-type semiconductors have a larger electron-to-hole concentration, and p-type semiconductors have a larger hole-to-electron concentration. The process of doping intentionally introduces impurities into the semiconducting layers for the purpose of changing electrical properties, e.g. changing the electron and hole concentrations of the semiconductor. The depletion layer is a region in a semiconductor where no mobile charge carriers are present. Depletion layer acts like a potential barrier that opposes the flow of electrons from n-side and holes from p-side. Bias may include the application of a voltage across a p-n junction. For forward bias, there is a positive difference between the p-type and n-type semiconducting layers. For reverse bias, there is a negative voltage difference between the p-type and n-type semiconducting layers.

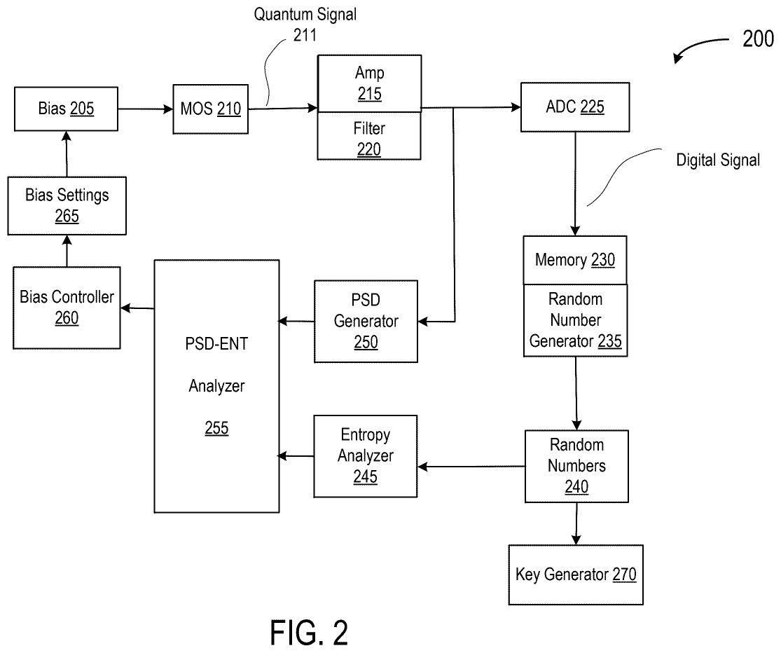

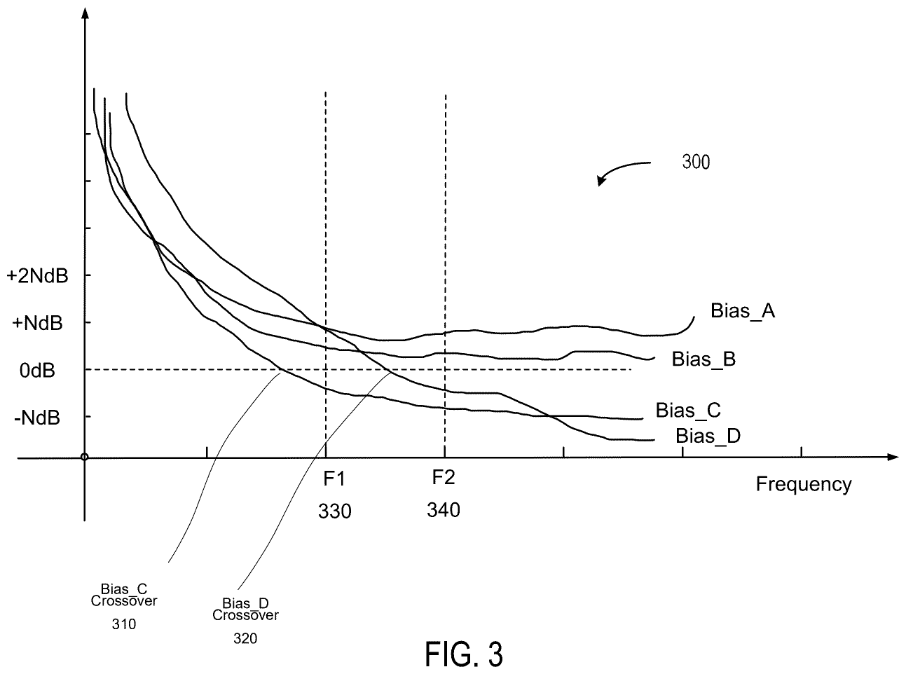

FIG. 2 illustrates a system 200 for generating high-entropy random numbers through quantum effects in accordance with an embodiment. Additional aspects of system 200 illustrated in FIG. 2 include bias 205, Metal-Oxide-Semiconductor (MOS) device 210, quantum signal 211, amplifier 215, filter 220, Analog to Digital Converter (ADC) 225, memory 230, random number generator (RNG) 235, random numbers 240, entropy analyzer 245, PSD generator 250, PSD-ENT analyzer 255, bias controller 260, bias settings 265, and key generator 270. Additional aspects of how FIG. 2 may be operated, how various components relate to one another, and how the system is used for random number generation are provided with reference to FIG. 3. For example, system 200 may be used to perform the methods described herein.

The components described above are connected by electrically conducting signal paths. The components may be mounted on a substrate, such as a printed circuit board or an integrated circuit chip. In some embodiments, digitization and digital signal processor components, or equivalents, can be on the same substrate as the other electronic components. This so-called mixed-signal circuit could be implemented, for example, on an application-specific integrated circuit (ASIC). In other embodiments, either or both the digitization and the digital signal processor component could be separate from the substrate. The electronic components can, for example, be independent electronic components or integrated components. The circuit can be a discrete circuit or an integrated circuit, or a mixed-signal integrated circuit. In some examples, not all components may be included or operating in system 200. For example, in some embodiments, entropy analyzer 245 or PSD-ENT analyzer 255 may be omitted or not functional. In some embodiments, changing or improving a bias setting (e.g., a bias current or bias voltage) may be based on improving the strength of the quantum signal and based on a NPSD or PSD.

The Metal-Oxide-Semiconductor (MOS) device 210 may serve to generate quantum signal (QS) 211. The MOS device 210 may be a field-effect transistor (MOSFET), which may operate by controlling the flow of electrons or holes across a channel using an electric field. The “metal” in the name refers to the gate material, the “oxide” to the insulating layer between the gate and the channel, and the “semiconductor” to the substrate that forms the channel. In the specific application of quantum random number generation, MOS 210 is not used in its conventional role of switching or amplification. Instead, it is employed for its quantum mechanical properties. By applying a electric field across the MOS structure, electrons are forced to tunnel through the insulating layer, creating what is known as shot noise—a type of electronic noise which can be used as an entropy source for random number generation. Some embodiments of the present invention relate to the shot noise emerging primarily from FN-tunneling processes.

System 200 allows the operation of MOS device 210 under conditions that favor the expression of quantum mechanical properties, such as for example, quantum tunneling. This may be achieved by applying a precise and adjustable bias to the device, carefully controlled to strike a balance between maximizing the QS and preventing any potential damage due to excessive electric fields. Thus, the disclosed technology and system 200 allows for the use of MOS devices to generate quantum signals in a known, controllable, and measurable way.

The term “quantum signal” may refer to the electrical signal that arises due to quantum mechanical phenomena, such as quantum tunneling, occurring within the MOS device when subjected to the appropriate electrical conditions. These fluctuations are the essence of QS 211 and represent a source of entropy due to their inherent randomness. Thus, the quantum signal may contain properties that are fundamentally rooted in the principles of quantum mechanics.

The quality of QS 211 is important to generate high quality random numbers. If the bias applied to the MOS is not optimal, the QS will exhibit a weak quantum component, reducing its effectiveness as an entropy source. It might be overwhelmed by other forms of noise influenced by temperature or electromagnetic interference (EMI), rather than the desired quantum tunneling effects. This makes QS 211 suitable for applications that require unpredictability, such as cryptographic systems where the security of the keys depends on the randomness of their generation. The QS 211 produced by MOS device 210 can thus be a raw form of entropy which, after subsequent processing, forms the basis for generating random numbers that can be trusted for their unpredictability and resistance to prediction or replication.

Amplifier 215 may increase the amplitude of the quantum signal (QS) 211 emanating from the MOS device 210. This amplification ensures that the signal's power level is sufficient for accurate filtering and subsequent digital conversion. Amplifier 215 may amplify the signal without significantly distorting its quantum properties, which include the random fluctuations that are helpful to generating high entropy. As one non-limiting example, the design of amplifier 215 may include low-noise characteristics to prevent the introduction of additional, non-quantum noise during the amplification process.

Filter 220 may be used to preserve the integrity of the QS 211 by allowing only the desired frequencies to pass, such as those that contribute to the randomness necessary for the RNG process. The filter might be designed to have a particular frequency response that matches the characteristics of the quantum noise to ensure that the signal forwarded to ADC 225 is clean and retains its quantum nature.

ADC 225 may be any digitization component, which can convert an analog signal to a digital signal, such as a string of digital bits representing an analog signal. Depending on the embodiments, ADC 225 may be selected from ADCs with desired sampling rate, accuracy, and resolution. ADC 225 may be configured to match the bandwidth of random signals generated out of quantum tunneling. In some examples, the bandwidth may be known based on the bias provided in system 200.

Memory 230 may serve as a temporary storage unit for the digital signal converted by ADC 225. It may hold the digitized quantum signal data, ensuring a buffer for smooth and continuous processing. This storage may allow for the accumulation of sufficient data to be analyzed and processed by RNG 235, thereby ensuring consistency and reliability in the random number generation process. RNG 235, connected to Memory 230, may be used to generate random numbers 240 from the stored digital signal. It may use algorithms to extract randomness from the digitized quantum signal. These algorithms may include statistical methods, entropy extraction techniques, and other computational processes designed to maximize the randomness and unpredictability of the output. RNG 235′s ability to produce random numbers with high entropy is helpful, especially for applications in cryptography where the security of the cryptographic keys depends on the quality and unpredictability of these random numbers. RNG 235 in system 200 can be implemented using various types of hardware, each with its own advantages, depending on the specific requirements of the application. For example, RNG 235 may include or be implemneted on an Application-Specific Integrated Circuits (ASICs) or Central Processing Unit (CPUs).

Random numbers 240 may be any set of random numbers which may be generated by system 200. Random numbers 240 may contain certain characteristics, such as high entropy (exhibit a high level of unpredictability and randomness), uniform distribution (each number within the specified range has an equal probability of being generated), and lack of predictability (there should be no discernible pattern or predictability in the sequence of numbers generated, making it difficult for an observer or attacker to predict future numbers based on past values). Additional statistical properties of random numbers may be used.

In some embodiments, the random numbers 240 may be used for the creation of cryptographic keys such as at key generator 270.

System 200 may be configured to harness a quantum signal (QS) 211 from an optimally biased Metal-Oxide-Semiconductor (MOS) device 210. MOS device's 210 output is tuned through an adjustable bias, such as bias 205, which may be chosen to increase the quantum component of a signal being generated or outputted from MOS device 210. QS 211 undergoes amplification and filtering to produce an analog signal of sufficient quality, which is then converted into a digital format by Analog to Digital Converter (ADC) 225. This digital signal is stored or processed in conjunction with memory 230. Memory 230 may also contain a random number generator 235, which may process a digital signal, digital information, or other additional information obtained from ADC 225, to produce random numbers. These random numbers may be used by Key Generator 270 to create cryptographic keys.

The generated random numbers may also be provided to an entropy (ENT) analyzer 245 and a PSD generator 250. Additionally, the system comprises an entropy (ENT) analyzer 245 and a Power Spectrum Distribution (PSD) generator 250, both receiving inputs from various stages of the signal processing flow to evaluate the signal's randomness. Outputs from the ENT analyzer 245 and PSD generator 250 converge at the PSD-ENT analyzer 255, which conducts a comprehensive analysis of both digital and analog data to ascertain and preserve the signal's high entropy level, indicative of randomness. This systematic monitoring and adjustment via PSD analysis are helpful in maintaining the integrity of the random numbers 240 generated by system 200. Entropy Analyzer 245 may implement entropy estimation tests (e.g., non-IID track tests) on any set or stream of random numbers. The test results may indicate how many bits per byte have entropy. Algorithms which may be implemented in PST-ENT anlayzer 255 may taken an additional factor to determine whether a separate bias setting is “better” or improved from the first bias setting for the system. This assessment may be complementary to the NPSD related tests. Together, two factors (e.g., the NPSD test and the PSD-ENT analyzer analysis) may be checked for agreement of an improved bias setting. However, in some situations, the two factors may not disagree (e.g., heat based entropy sources can appear to have low NPSD but have high entropy). As an optimal or improved bias for quantum entropy is desired, such situations (e.g., when heat based entropy is high) will be remembered or stored in the system to avoid or be included in a list of avoided settings.

ENT Analyzer 245 may assess the quality of the random numbers generated by the system. It may compute the entropy of the random numbers, providing a measure in bits per byte, which is helpful for evaluating the randomness of the signal. As the entropy is derived from the same amplified QS 211 used in other parts of system 200, the use of ENT Analyzer 245 offers additional information. Unlike power, which measures signal intensity, entropy assesses the randomness, making it an “orthogonal” and informative metric for determining the quality of the bias setting on the MOS device 210.

PSD generator 250 is responsible for converting the amplified QS 211, such as within a 0-1 volt range, into a PSD at the current bias point. The amplified QS can be thought of as behaving like a ‘sparkler’, with sporadic spikes of intensity. PSD generator 250 may employ any number of techniques or methods to transform this signal into a PSD. A person of skill in the art will appreciate the use of a wide number of techniques for the same.

PSD-ENT Analyzer 255 operates with the knowledge of the current bias setting to construct the “ideal 0 dB line” for that specific bias condition. The ideal line is further explained below. As the ideal 0 dB line varies at different bias settings, PSD-ENT Analyzer 255 also creates the Normalized Power Spectrum Distribution (NPSD) from the output of the PSD generator and the bias setting. It then compares the NPSD to the ideal 0 dB line, calculating, for example, the least absolute difference (LAD) through Root Mean Square (RMS) methods. This comparison allows the system to discern whether the current bias setting is already optimal or if an adjustment, quantified by the change delta_X, is necessary to achieve the desired bias point for optimal random number generation.

Bias 205, Bias Settings 265, and Bias Controller 260 can control the electrical conditions (e.g., bias conditions) necessary for the MOS device 210 to generate a high-quality quantum signal for random number generation.

Bias 205 may include any mechanism, such as a steady state driver, that provides the necessary electrical conditions to MOS device 210. Bias 205 is responsible for supplying a controlled voltage or current to MOS device 210, and its adjustment directly impacts the strength and quality of the quantum component in the QS.

Bias Settings 265 encompass the specific parameters or values that dictate how Bias 205 is applied to the MOS device 210. These settings can include any bias related parameters such as power spectrum effects, frequency, current, desired bias, voltage, electrical properties, input frequency, and phase. The settings may be adjustable to tune bias to achieve the desired quantum tunneling effects within the MOS device. The Bias Settings 265 determine the range and intensity of the voltage or current applied, ensuring that the MOS device operates within an optimal quantum signal-producing regime. In some examples, the bias settings 265 may be saved in a file.

Bias Controller 260 is the component that manages and adjusts Bias Settings 265 in response to feedback from the system, particularly from the Power Spectrum Distribution (PSD) and entropy analysis conducted by PSD-ENT Analyzer 255.

FIG. 3 illustrates plot 300. Illustrated in FIG. 3 is a power spectrum analysis utilized for fine-tuning the Metal-Oxide-Semiconductor (MOS) device within a system to generate quantum signals for high-entropy random number generation, such as system 200 described above with respect to FIG. 2, in accordance with an embodiment.

The analysis graphically represents the normalized power spectrum distribution (PSD) on the vertical axis and a frequency on the horizontal axis. The vertical axis may represent power in decibel units while the horizontal axis may represent the frequency of the amplified or unamplified QS. The power spectrum is measured in decibels and is “normalized” or “zeroed” with a reference level indicative of optimal quantum tunneling effects. The 0 dB line delineates the theoretical ideal power spectrum level, where the quantum effects are maximized for the MOS device. The 0 dB line may be derived from equations related to FN tunneling or other expected quantum effects. This “ideal” line, which is theoretically derived, signifies a condition where the entropy and randomness of the quantum signal are maximized. The 0 dB line also implies or characterizes a bias or other setting at which the quantum signal is most ideal for random number generation due to being “white” and “flat.” The distribution of the PSD may represent how “flat” the signal is which is better for random number generation.

Illustrated in FIG. 3 are four example biases, illustrated as four curves. However, a person of skill in the art will appreciate that any number of bias curves may be generated. The curve closest to the 0 dB line without crossing below the curve represents the most desirable bias setting. A curve that crosses under the 0 dB line implies that the signal is quieter or more silent, which is less desirable for generation of random numbers. This may be the case as it is not desirable to move under the 0 dB line as other non-quantum effects will become prominent and the quantum nature of the signal obtained cannot be guaranteed. A curve above the 0 dB line (at a given frequency or throughout the frequency range) implies a higher presence of noise. However, there is a limit to how far above the 0 dB line the curve may be without non-quantum (and thus, less random) effects predominating what is represented in a PSD.

Within the frequency range of interest, demarcated by Freq_Y 330 and Freq_Z 340, the objective is to adjust the bias of the MOS device such that at least one of the empirical bias response curves—Bias A, Bias B, Bias C, and Bias D—aligns with the 0 dB line. This alignment ensures that the quantum signal's power spectrum maintains a high entropy level. It may be noted that the bias response curves may be empirically obtained. Thus, these bias response curves provide a measurement which may vary from device to device.

Bias C and Bias D are observed to have crossover points with the 0 dB line at crossover 310 and crossover 320, respectively. These crossover points represent the frequencies at which the power spectrum of the quantum signal matches the ideal level, which is important for maintaining the randomness and unpredictability necessary for secure cryptographic key generation. Another advantage of the disclosed technology is the ability to determine the best frequency of operation for the MOS device 210, which corresponds to these crossover points.

The crossover points, crossover 310 and crossover 320, signify where the bias settings are optimal, and the MOS device's output aligns with a theoretically ideal signal. Knowing the specific crossover point may allow for control over the MOS device's operation, ensuring that it functions within the quantum regime that is most conducive to generating random numbers with the highest quality of entropy. Thus, the disclosed embodiment in FIG. 3, therefore, is not only a tool for bias optimization but also a map that guides the selection of the best operational frequency for the MOS device based on the power spectrum's behavior. This mapping is helpful for the system's efficacy and is indicative of the disclosed technology's strength in optimizing quantum-based random number generation processes.

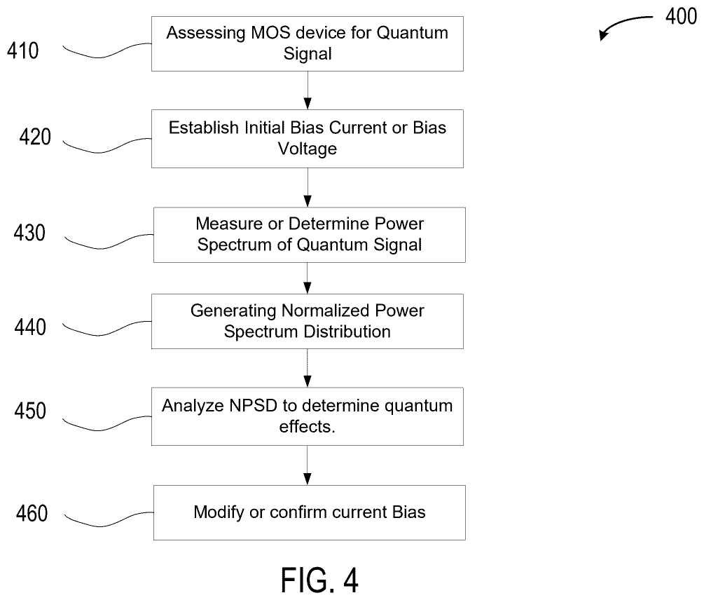

FIG. 4 outlines method 400 for calibrating and validating a Metal-Oxide-Semiconductor (MOS) device for optimal quantum signal generation in accordance with an embodiment. Each step, from 410 to 460, represents a phase in the process of ensuring that the MOS device functions at a high level of efficiency for random number generation. Method 400 may be performed on a system which may include any combination of the components described with respect to system 200 in FIG. 2 above. Method 400 can be implemented to run automatically, cither periodically based on a set time interval or in response to environmental changes that may affect the device's performance. In some embodiments, some steps may be optional.

Step 410 involves assessing the MOS device to confirm it is a “good” component, such as a component capable of producing a reliable quantum signal. This step includes generating an appropriate Power Spectrum Distribution (PSD) model that characterizes the expected power output across a spectrum of frequencies and a range of safe bias currents. The PSD model may serve as a benchmark for the MOS device's expected performance. In some examples, the PSD may be established or stored in memory, such as memory 230 or Power Spectrum Distribution (PSD) generator 250. These examples may include examples where a device or system is “tuned” at a factory or during manufacturing. In other examples, the PSD model may be generated or run during the operation of a device or system in the field. In such examples, the PSD model may be generated or ran “live” in the field. In some examples, step 410 may be optional or omitted. For instance, step 410 may be optional when the characteristics of the MOS device are known. The PSD may be generated based on an FN model or other appropriate models.

In step 420, an initial bias (e.g., an initial bias current (“i”)) for the MOS device may be established or set. This step may include determining the noise floor power—the lowest level of detectable signal in the system—and setting the bias to the closest (e.g., lowest) current above this noise floor. This ensures that the quantum signal is distinguishable from the inherent electronic noise of the system. In some examples, the step may be optional, such as when for example the bias required is known or can be theoretically determined. In some examples, this process may be empirical. In some embodiments, “noise floor” may be a state of output when (i) a current is small or at a minimum amount (which may depend on the specific MOS device, as some devices may need a minimum amount of bias current before any tunneling may occur (e.g., over a Zener diode or tunnel diode)), (ii) the expected or known QS is negligible or close to 0 (e.g., the NPSD is negative when compared to the 0 dB line or the tunneling current is not the bias current), (iii) there is some amount of inherent electrical noise in the system (e.g., heat based/Johnson-Nyquist noise, EMI, parasitic signals), or (iv) PSD has some non-zero power present on a PSD graph. A process of distinguishing a QS from other signals may include measuring the PSD for each bias setting.

Step 430 may include measurement of the power spectrum of the non-amplified or amplified Quantum Signal (QS). A Desired Frequency of Operation (DFO) may be nominated, and the PSD is obtained for frequencies within the DFO. This may thus capture the signal behavior where the quantum effects are expected to be most significant. For example, with reference to FIGS. 3, F1 330 and F2 340 define the DFO. Within this range the power spectrum of the quantum signal may be measured. The measurement may later be used to determine the quantum effects.

Step 440 may entail generating the Normalized Power Spectrum Distribution (NPSD). Generation of the NPSD may use a formula 2qi, with ‘q’ representing the elementary charge of an electron and ‘i’ the bias current, as the denominator for normalization. Thus, the power spectrum obtained in step 430 may be normalized with this denominator. Once obtained, the NPSD may be plotted. Frequency may be plotted on the X-axis, while the NPSD decibel values (e.g., in increments of “2qi”) may be plotted on the Y-axis. One example plot is illustrated in FIG. 3. The 0 dB line in FIG. 3 may illustrate the “ideal” bias setting.

Step 450 may involve analyzing the NPSD to determine the presence and characteristics of quantum tunneling effects, such as those related to Fowler-Nordheim (FN) tunneling. The analysis looks for contributions in terms of power and frequency band and identifies any degradation in the signal that follows a 1/f pattern, which could indicate a loss in signal quality.

Step 460 may be a modification or optimizing step. If NPSD analysis indicates sub-optimal biasing, the bias settings may be adjusted according to a change algorithm. As one example, the change algorithm may include evaluating whether the existing bias point is optimum or requires modification by a small delta or change. The amount of delta may depend on several factors: the current bias setting or bias point, the applicable PSD model, the PSD within the frequency range of interest, and the entropy content as determined by the ENT Analyzer (e.g., ENT Analyzer 255) over the operation's duration. Step 460 may be iterated to obtain more optimal operating conditions for the MOS device, ensuring it generates a QS with high entropy for random number generation.

Method 400 may be automated to execute these steps at regular intervals, ensuring the MOS device continuously operates at high efficiency. Alternatively, the method can be triggered by environmental factors such as temperature, humidity, or voltage fluctuations. This responsive approach allows the system to maintain the integrity of the quantum signal generation process in the face of changing conditions, thereby ensuring a consistent supply of high-quality random numbers for secure cryptographic applications. Such adaptability is helpful for maintaining system reliability in varying operational environments.

Method 400 may further contain additional steps, such as the use of entropy from a random number generation to enhance or complement the analysis performed by the steps above. For example, the use of entropy from random numbers can provide additional detail to the PSD model. Information which is similar to information related to frequency or the power spectra may also be measurable from the raw random numbers (e.g., when the order of collecting or measuring the raw random numbers is maintained and no variations on the conditioning process occurs). In some examples, an ADC's limited input range can have a clipping effect on the range of the digital values (which may lead to extreme values at 0 or 0×FFF for example). In other examples, some frequencies can be lost or resonant frequencies may show up in the random numbers, (which may be related to attributed to the ADCs sampling behavior). These effects may be considered at this step.

Thus, embodiments of the present invention have identified a new utility of MOS devices.

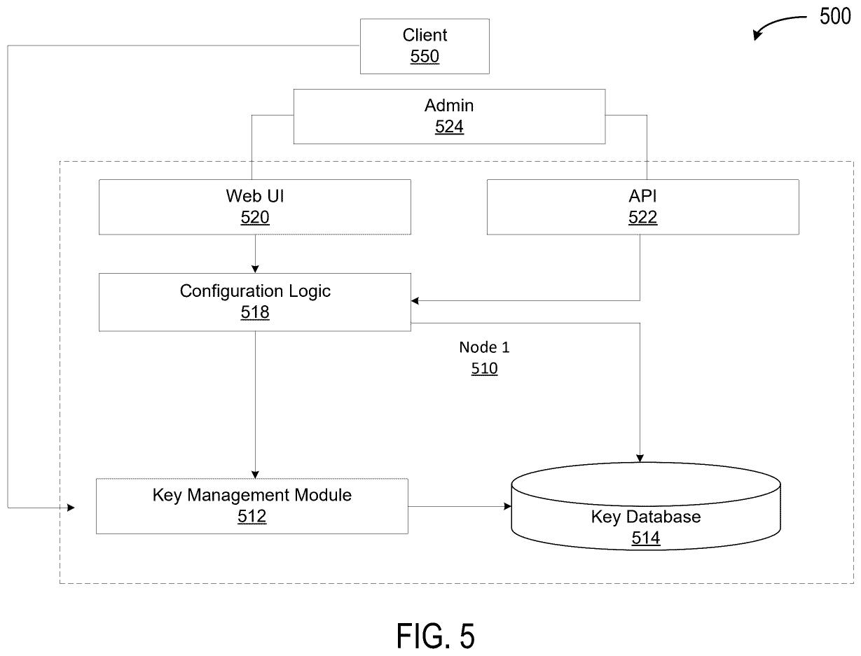

FIG. 5 is a simplified block diagram illustrating a key management system in accordance with an embodiment. The random bits generator described above can be part of a key management system and can be used for generating key material, such as random numbers, for the key management system. FIG. 5 illustrates an example of a key management system. The node 1 (510) can include a key management module 512 and a key database 514. The key management module 512 can perform operations on the key database 514. The key management module 512 can communicate with the key database 514. In some examples, the key management module 512 can communicate with a key database module in a different node.

The node 1 (510) can further include a configuration logic module 518, a web UI 520, and an API 522. The configuration logic module 518 can coordinate operations on key database 514. And both the web UI 520 and the API 522 can communicate with the configuration logic module 518. In some examples, an admin 524 can communicate with the web UI 520 and the API 522. In such examples, the admin 524 can include external administrator functionality to communicate with the configuration logic module 518. The external administrator software can setup and configure the key database 514 by communicating with the configuration logic module 518, or any configuration logic module 518 in the cluster. In some examples, the admin 524 can use the web UI 520 or the API 522 to communicate with the configuration logic module 518.

A client 550 can communication with the node 1 (510) using the key management module 512. In some examples, the client 550 can include client software to access a key database by interfacing with a key management module in any node in a cluster. In addition, an administrator connected to a node can initiate operations on a database on any nodes in the cluster. In addition, via a configuration logic module, the administrator can initiate operations on database instances, including create, destroy, start, stop, and reconfigure.

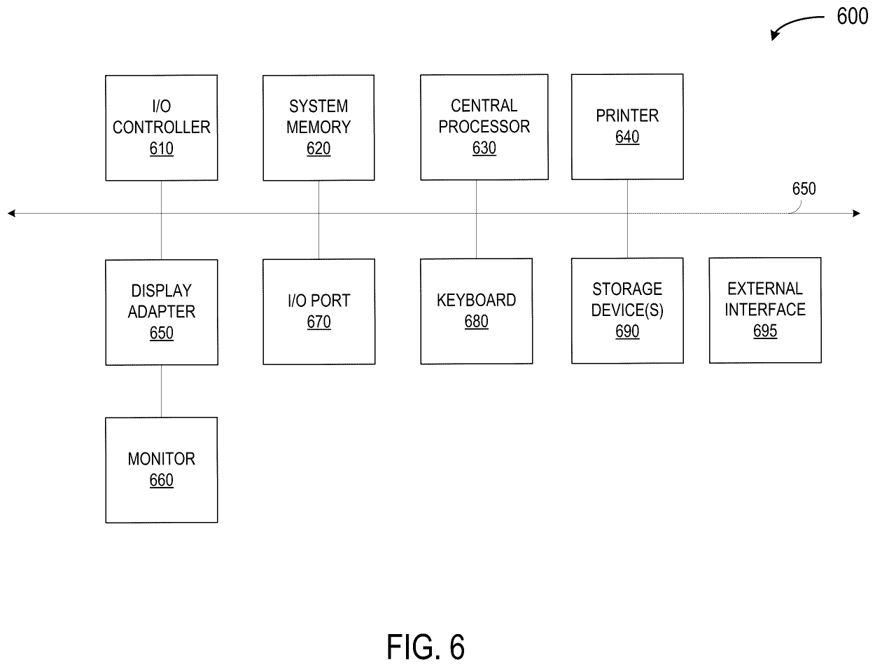

FIG. 6 is a simplified block diagram illustrating an example of a computer system that may be configured to perform one or more operations of the processes described herein. Merely as an example, the computer system 600 may be configured to perform the method of FIG. 4. Other computer systems may also be used. Any of the computer systems mentioned herein may utilize any suitable number of subsystems. Examples of such subsystems are shown in FIG. 6 in computer system 600. In some embodiments, a computer system includes a single computer apparatus, where the subsystems can be the components of the computer apparatus. In other embodiments, a computer system can include multiple computer apparatuses, each being a subsystem, with internal components.

The subsystems shown in FIG. 6 are interconnected via a system bus 650. Additional subsystems such as a printer 640, keyboard 680, storage device(s) 690, monitor 660, which is coupled to display adapter 620, and others are shown. Peripherals and input/output (I/O) devices, which couple to I/O controller 610, can be connected to the computer system by any number of means known in the art such as input/output (I/O) port 670 (e.g., USB, FireWire®). For example, I/O port 670 or external interface 695 (e.g., Ethernet, Wi-Fi, etc.) can be used to connect computer system 600 to a wide area network such as the Internet, a mouse input device, or a scanner. The interconnection via system bus 650 allows the central processor 630 to communicate with each subsystem and to control the execution of instructions from system memory 620 or the storage device(s) 690 (e.g., a fixed disk, such as a hard drive or optical disk), as well as the exchange of information between subsystems. The system memory 620 and/or the storage device(s) 690 may embody a computer readable medium. Any of the data mentioned herein can be output from one component to another component and can be output to the user.

A computer system can include a plurality of the same components or subsystems, e. g., connected together by external interface 695 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

In the foregoing specification, aspects of this disclosure are described with reference to specific embodiments thereof, but those skilled in the art will recognize that this disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Where components are described as being configured to perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

While illustrative embodiments of the application have been described in detail herein, it is to be understood that the inventive concepts may be otherwise variously embodied and employed, and that the appended claims are intended to be construed to include such variations, except as limited by the prior art.

What is claimed is:

1. A method for optimizing a bias setting in a semiconductor device to facilitate quantum signal generation, the method comprising:
a) determining a theoretical behavior for the semiconductor device;
b) measuring a power spectrum associated with the quantum signal from the semiconductor device for a first bias setting;
c) normalizing the measured power spectrum to generate a distribution indicative of quantum tunneling effects; and
d) adjusting the first bias setting based on the normalized power spectrum to a second bias setting to improve the quantum signal for random number generation.

2. The method of claim 1, further comprising measuring an entropy content of content derived from the quantum signal, wherein the entropy content is indicative of the randomness quality for cryptographic key generation.

3. The method of claim 1, wherein the semiconductor device is a Metal-Oxide-Semiconductor (MOS) device.

4. The method of claim 1, wherein determining the suitability includes assessing whether the semiconductor device is capable of producing a measurable quantum signal.

5. The method of claim 1, further comprising analyzing the normalized power spectrum to detect the presence of quantum tunneling effects.

6. The method of claim 1, wherein the first bias setting is generated based on an initial noise floor power determination of the semiconductor device.

7. The method of claim 1, wherein normalizing the measured power spectrum includes using a factor related to the elementary charge of an electron and the bias current.

8. The method of claim 1, wherein the second bias setting is adjusted iteratively based on a continuous feedback loop involving the normalized power spectrum.

9. The method of claim 1, wherein the random number generation is utilized in cryptographic processes.

10. The method of claim 1, further comprising storing the optimized quantum signal in a memory unit prior to random number generation.

11. The method of claim 1, wherein the semiconductor device comprises a plurality of MOS devices, and the second bias setting is optimized across the plurality of devices to produce a composite quantum signal.

12. The method of claim 1, wherein the theoretical behavior for the semiconductor device is based on Fowler-Nordheim (FN) effects.

13. The method of claim 12, wherein the theoretical behavior is used to determine a zero line against which to compare the power spectrum or normalized power spectrum for quantum effects.

14. A method for generating random numbers, comprising:
a) assessing the suitability of a MOS device for generating quantum tunnelling-based shot noise;
b) biasing the MOS device to induce quantum tunnelling;
c) measuring the generated shot noise and evaluating an entropy content of the measured noise;
d) post-processing the measured noise to remove biases and increase entropy density;
e) utilizing or digitizing the processed noise as a source of entropy in random number generation for cryptographic applications.

15. The method of claim 14, wherein a behavior of the MOS device is based at least in part on Fowler Nordheim tunneling.

16. A system for generating random numbers, comprising:
a) a semiconductor structure designed to exhibit quantum tunnelling effects when subjected to a suitable bias current;
b) a biasing module configured to adjust the bias current to increase the quantum tunnelling effects within said semiconductor structure;
c) a noise measurement module configured to capture a shot noise generated by the quantum tunnelling effect;
d) a data processing module configured to evaluate entropy of the generated random numbers based on the captured shot noise;
e) a conditioning module configured to apply post-processing techniques to the generated random numbers to enhance entropy density.

17. The system of claim 16, wherein the semiconductor structure is a MOS structure.

18. The system of claim 17 wherein the MOS structure is fabricated using a standard MOS process with a feature size of no more than 40 nm.

19. The system of claim 16 wherein the MOS structure contains a triangle barrier as part.

20. The system of claim 19 wherein the MOS structure is designed to include Fowler Nordheim tunneling.
